(19) United States
(12) Patent Application Publication
(10) Pub. No.: US 2007/0018456 A1
(43) Pub. Date: Jan. 25, 2007

(54) Smartloc whirlpool fitting

(75) Inventor: Thomas J. Sisk, Tottenham (CA)

Correspondence Address: CARLSON, GASKEY & OLDS, P.C., 400 WEST MAPLE ROAD, SUITE 350, BIRMINGHAM, MI, 48009, US

(73) Assignee: Masco Corporation

(21) Appl. No.: 11/184,515

(22) Filed: Jul. 19, 2005

(51) Int. Cl. F16L 25/00

(52) U.S. Cl. 285/420

(57) ABSTRACT

A mechanical locking device is used to secure joints between pipes and pipe fittings. The mechanical locking device fits around the joint and includes teeth that provide a one-way locking mechanism for tightening and securing the joint. As pressure is applied the locking device is reduced in circumference. The smaller circumference of the locking device applies pressure to seal the joint.

### BACKGROUND OF THE INVENTION

This invention relates to a method and apparatus for securing connections in tubs and showers.

Tubs, in particular those having whirlpool jets or multiple water outlets, require pipe fittings at each outlet location. The pipe fittings secure a supply pipe to a corresponding water outlet. Joints between the pipe fittings and the supply pipes must be sealed to prevent leakage.

Typically, the supply pipes and the pipe fittings are manufactured from polyvinyl chloride (PVC) material. PVC cement is brushed on an end of the supply pipes to seal the joints between the supply pipes and the pipe fittings. Using PVC cement is an inefficient method of sealing the joints. The PVC material of the supply pipes must be heated until flexible in order to assemble the supply pipe between pipe fittings. The PVC is heated prior to cement application thus increasing the discharge of harmful chemicals into the environment.

The pipe fittings commonly have a tapered end that corresponds to an end of the supply pipe. The tapered pipe end fits together with the end of the supply pipe. Prior to assembly, the tapered end of the PVC supply pipe is heated. PVC cement is applied to the heated end. After application of the cement the tapered ends are fitted together. Pressure must be continually applied to the joint between the supply pipes and pipe fittings while the cement is drying. The pressure ensures a proper set between the supply pipes and pipe fittings. The cement must dry completely before the pressure can be released and manufacturing can continue.

Another disadvantage with this type of pipe fitting is that the PVC cement is a volatile organic compound (VOC). VOCs can be harmful to the environment. VOC use must be registered with environmental regulation industries, and strict handling procedures must be followed. Thus, using VOC materials increases material and handling costs, adding to the manufacturing expense of the tubs and showers. Applying the PVC cement to the heated PVC tube increase the discharge of harmful chemicals into the surrounding environment.

An improved method and apparatus for securing pipes and pipe connections, which eliminates the use of VOC materials, is needed.

### SUMMARY OF THE INVENTION

The invention is a mechanical fitting for securing pipes and pipe fittings. A fitting attachment device fits over a joint between the pipe and the pipe fitting. The fitting attachment device has a fitting body shaped to correspond with the pipe fitting.

Attached to the fitting body is a locking mechanism. The locking mechanism includes securing surfaces that are used to apply pressure to the locking mechanism. As pressure is linearly applied to the securing surfaces, the fitting body is reduced in circumference. The smaller circumference of the fitting body applies pressure around the joint between the pipe fitting and the pipe.

The locking mechanism has two overlapping portions. Preferably, one portion is a male extension that is shaped to correspond to a female receptacle. As pressure is applied to the locking mechanism, an amount of overlap between the two overlapping portions increases. That is, the male extension is received within the female receptacle.

Teeth located on each portion of the overlap engage with each other. The teeth provide a one-way locking mechanism for securing the fitting attachment device. Thus, when the pressure is released the teeth prevent the locking mechanism from expanding. Once locked, the pipe and pipe fitting are sealed.

The fitting body has an inner surface with ridges to surround the pipe fitting when assembled. The ridges assist in retaining the fitting body in the proper location and assist in sealing the pipe and pipe fitting.

The mechanical attachment eliminates the need for PVC cement to seal the joint between the pipe and pipe fitting. Thus, use of VOCs within the manufacturing process can be reduced or eliminated. In addition, the mechanical attachment saves time during manufacturing because drying time is required.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a pipe fitting assembly of the present invention;

FIG. 2 is a pipe fitting attachment device; and

FIG. 3 is a cross-section of the pipe fitting attachment device viewed from line A-A.

### DETAILED DESCRIPTION OF THE PREFERRED EMBODIMENT

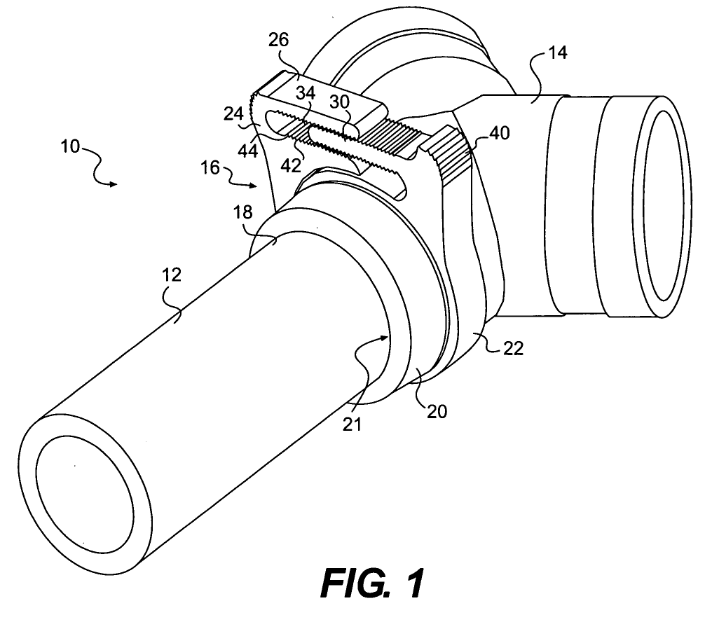

FIG. 1 shows a pipe fitting assembly 10 having a pipe 12, a pipe fitting 14, and a fitting attachment device 16. In the example shown, the pipe 12 is an outlet pipe for a whirlpool tub, but the pipe 12 could be used for other types of applications. The pipe 12 has a fitting end 18 that mates with the pipe fitting 14. The pipe fitting 14 has a pipe end 20 that mates with the pipe 12. The fitting end 18 and the pipe end 20 are coupled together in an overlapping relationship, to form a joint 21. In the example shown, the fitting end 18 is inserted into the pipe end 20. However, an opposite configuration could also be used with the pipe end 20 being inserted into the fitting end 18.

The fitting attachment device 16 fits over the joint 21. The fitting attachment device 16 has a fitting body 22 with a shape that generally corresponds to a shape of the pipe fitting 14. Preferably this shape is circular. As shown in this embodiment, the fitting body 22 completely surrounds the pipe fitting 14. However, the fitting body 22 may only partially surround the pipe fitting 14 depending on a desired joint configuration.

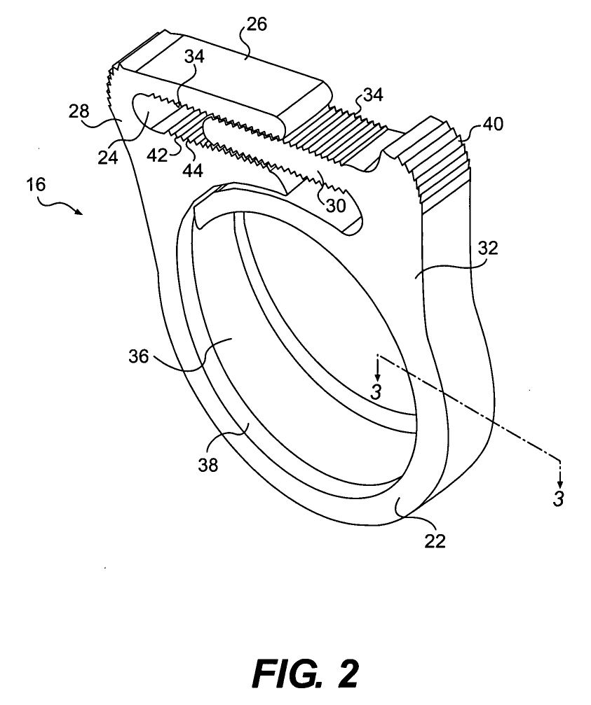

FIG. 2 shows a perspective view of the fitting attachment device 16 without the pipe 12 and pipe fitting 14. Attached to the fitting body 22 is a locking mechanism 24. The locking mechanism 24 has a first portion 26 extending from a first end 28 of the fitting body 22 and a second portion 30 extending from a second end 32 of the fitting body 22. The first portion 26 overlaps with the second portion 30. That is, in the example shown, the first portion 26 forms a U-shaped female slot and the second portion 30 forms a U-shaped male extension which corresponds to the U-shaped female slot. However, an opposite configuration could also be used with the first portion 26 forming a male extension and the second portion 30 forming a female receptacle.

Teeth 34 located on the first portion 26 and the second portion 30 are configured to correspond to each other at the overlap. The teeth 34 allow the overlap between the first portion 26 and the second portion 30 to be increased, but do not allow the overlap to be decreased. This provides a one-way locking mechanism for the fitting attachment device 16. The teeth 34 are located on each side of the male extension and correspond to teeth 34 on each side of the female receptacle. The teeth 34 have an angled forward surface 42 which allow linear movement of the first portion 26 and the second portion 30 toward each other. However an angled back surface 44 will catch against the teeth 34 of an opposing portion to prevent backwards movement. Although angled teeth 34 are shown, other shapes allowing one-way movement could also be used.

The locking mechanism 24 also includes securing surfaces 40 at each end of the fitting body 22. The securing surfaces 40 provide relatively flat surfaces that are used to apply pressure to the locking mechanism 24. Pressure may be applied by hand, using pliers, or other similar securing devices device. The securing surfaces 40 may be textured, as shown, to aid the securing device in gripping the locking mechanism 24. Applying pressure to the securing surfaces 40 causes the securing surfaces 40 to move linearly toward each other.

As pressure is applied to the securing surfaces 40, the amount of overlap between the first and second portions 26 and 30 is increased. The fitting body 22 is reduced in circumference. The smaller circumference of the fitting body 22 applies pressure about an entire circumference of the pipe fitting 14 to seal the joint 21 between the pipe fitting 14 and the pipe 12. Once locked, pressure is released from the securing surfaces 40. The teeth 34 prevent the first portion 26 and the second portion 30 from moving away from each other. The fitting body 22 remains at a smaller circumference to provide compression sealing between the pipe fitting 14 and the pipe 12.

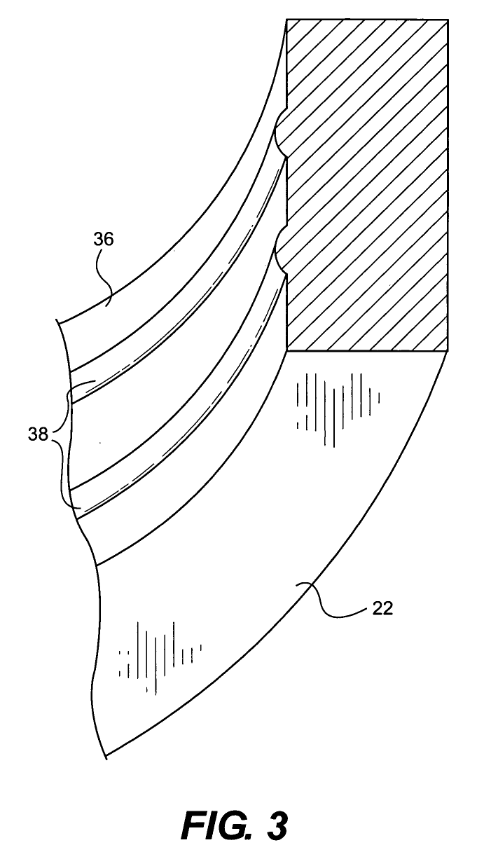

Referring to FIG. 3, a cross section of the fitting attachment device 16 through section A-A is shown. The fitting body 22 has an inner surface 36. The inner surface 36 is shaped to correspond to an outer surface of the pipe fitting 14. Ridges 38 located on the inner surface 36 form concentric rings to surround the pipe fitting 14 when assembled. The ridges 38 assist in retaining the fitting attachment device 16 in a proper location, and assist in sealing the pipe 12 and pipe fitting 14.

In the embodiment shown, the fitting attachment device 16 is molded as a solid piece. Preferably the fitting body 22 and the locking mechanism 24 are molded together as one piece. Alternatively, the fitting body 22 could be formed as a separate piece from the locking mechanism 24. In the embodiment disclosed the fitting body 22 is made from synthetic rubber such as ethylene propylene diene rubber (EPDM) and the locking mechanism 24 is made from a synthetic plastic. However other types of rubber, plastic, or other materials may be used to form the fitting body 22 and the locking mechanism 24.

Although the pipe 12 and pipe fitting 14 are discussed in application of a whirlpool tub, it should be understood that any type of application using pipes 12 and pipe connections may benefit from the present invention. In addition, the fitting attachment device 16 may be designed to correspond to different sizes and shapes of pipes 12 and pipe connections, such as rubber or plastic pipes and connections with elbow or tee shapes, for example.

The foregoing description is only illustrative of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A pipe fitting attachment device comprising:
a fitting body formed to at least partially surround a pipe; and
a locking mechanism attached to the fitting body to lock the fitting body around the pipe.

2. The pipe fitting attachment device as recited in claim 1, wherein the fitting body has an interior surface corresponding to an outer surface of the pipe.

3. The pipe fitting attachment device as recited in claim 2, wherein the interior surface has at least one ridge.

4. The pipe fitting attachment device as recited in claim 1, wherein the pipe is a polyvinyl chloride pipe.

5. The pipe fitting attachment device as recited in claim 1, wherein the pipe is an extension of a pipe fitting.

6. The pipe fitting attachment device as recited in claim 1, wherein the locking mechanism is a compression locking mechanism.

7. The pipe fitting attachment device as recited in claim 1, wherein the locking mechanism includes a first portion extending from a first end of the fitting body and a second portion extending from a second end of the fitting body, wherein the first portion and the second portion are movable relative to each other in response to a locking input force.

8. The pipe fitting attachment device as recited in claim 7, wherein the first portion includes teeth that interfit with teeth on the second portion.

9. The pipe fitting attachment device as recited in claim 1, wherein the fitting body and locking mechanism are molded plastic.

10. The pipe fitting attachment device as recited in claim 1, wherein the locking mechanism is a one-way locking mechanism.

11. The pipe fitting attachment device as recited in claim 1, wherein the locking mechanism moves linearly to apply compression about an outer circumference of the pipe.

12. A pipe fitting assembly comprising:
a pipe;
a pipe fitting coupled to the pipe to form a joint;
a locking mechanism including a body portion at least partially surrounding the joint; and
a locking portion that is engaged to provide a compression force against the joint.

13. The pipe fitting assembly as recited in claim 12, wherein the body portion has an interior surface corresponding to an outer surface of the joint.

14. The pipe fitting assembly as recited in claim 12, wherein the locking mechanism includes a first portion extending from a first end of the fitting body and a second portion extending from a second end of the fitting body, wherein the first portion and the second portion are movable relative to each other in response to a locking input force.

15. The pipe fitting assembly as recited in claim 14, wherein the first portion and the second portion moves in a linear direction toward each other to apply compression about an outer circumference of the pipe.

16. The pipe fitting assembly as recited in claim 14, wherein the first portion includes teeth that interfit with teeth on the second portion.

17. The pipe fitting assembly as recited in claim 16, wherein the first portion is a U-shaped male extension and the second portion is a U-shaped female receptacle shaped to receive the U-shaped male extension.

18. A method of securing a pipe fitting comprising:
a) coupling a pipe with a pipe fitting to form a joint;
b) positioning a fitting body to at least partially surround the mating joint; and
c) tightening a locking mechanism attached to the fitting body to secure the pipe to the pipe fitting.

19. The method as recited in claim 18, wherein the step c) includes clamping the locking mechanism to lock teeth on a first portion of the locking mechanism with teeth on a second portion of the locking mechanism.

20. The method as recited in claim 18, wherein the step c) includes applying linear force to the locking mechanism to reduce the circumference of the fitting body.
